(19) United States
(12) Patent Application Publication
(10) Pub. No.: US 2007/0112771 A1
(43) Pub. Date: May 17, 2007

(54) Directory entry locks

(75) Inventors: Mark J. Maybee, Boulder, CO (US); Matthew A. Ahrens, San Francisco, CA (US)

Correspondence Address: OSHA LIANG L.L.P./SUN, 1221 MCKINNEY, SUITE 2800, HOUSTON, TX, 77010, US

(73) Assignee: Sun Microsystems, Inc., Santa Clara, CA (US)

(21) Appl. No.: 11/432,082

(22) Filed: May 11, 2006

Related U.S. Application Data
(60) Provisional application No. 60/734,043, filed on Nov. 4, 2005.

(51) Int. Cl. G06F 17/30

(52) U.S. Cl. 707/8

(57) ABSTRACT

A method for modifying a directory entry, which includes receiving a request to modify the directory entry, determining whether a directory entry lock associated with the directory entry is present, instantiating the directory entry lock, if the directory entry lock associated with the directory entry is not present, waiting until the directory entry lock is released, if the directory entry lock is present, providing the directory entry lock to a caller of the request, placing an entry corresponding to the directory entry lock on a dynamic lock list associated with the directory, processing the request by the caller, releasing the directory entry lock once the request has been processed, and removing the entry corresponding to the directory entry lock from the dynamic lock list.

### CROSS REFERENCE TO RELATED APPLICATIONS

This application claims benefit of U.S. Provisional Application Ser. No. “Directory Entry Locks” (Application Ser. No. 60/734,043) filed on Nov. 4, 2005 in the names of Mark J. Maybee and Matthew A. Ahrens and is hereby incorporated by reference.

### BACKGROUND

A typical operating system includes a file system. The file system provides a mechanism for the storage and retrieval of files and a hierarchical directory structure for the naming of multiple files. More specifically, the file system stores information provided by the user (i.e., data) and information describing the characteristics of the data (i.e., metadata). The file system also provides extensive programming interfaces to enable the creation and deletion of files, reading and writing of files, performing seeks within a file, creating and deleting directories, managing directory contents, etc. In addition, the file system also provides management interfaces to create and delete file systems. File systems are typically controlled and restricted by operating system parameters. For example, most operating systems limit the maximum number of file names that can be handled within their file system. Some operating systems also limit the size of files that can be managed under a file system.

One common operation of a file system is the modification of the content of a directory associated with the file system, for example, changing a filename, adding a new filename, deleting a filename, etc. When a process using the file system (e.g., an application) attempts to modify the directory (e.g., modify a filename currently in the directory), the process obtains a lock on the entire directory and then proceeds to modify a specific entry (e.g., a filename) in the directory. If a subsequent process attempts to modify the directory while the current process is modifying the directory, the subsequent process must wait until the current process completes its modification of the directory and releases the lock associated with the directory. Thus, at most one process may be modifying the directory at any given time.

### SUMMARY

In general, in one aspect, the invention relates to a method for modifying a directory entry comprising receiving a request to modify the directory entry, determining whether a directory entry lock associated with the directory entry is present, instantiating the directory entry lock, if the directory entry lock associated with the directory entry is not present, waiting until the directory entry lock is released, if the directory entry lock is present, providing the directory entry lock to a caller of the request, placing an entry corresponding to the directory entry lock on a dynamic lock list associated with the directory, processing the request by the caller, releasing the directory entry lock once the request has been processed, and removing the entry corresponding to the directory entry lock from the dynamic lock list.

In general, in one aspect, the invention relates to a method for modifying a first directory entry and a second directory comprising receiving a first request to modify the first directory entry, receiving a second request to modify the second directory entry, instantiating a first directory entry lock and a second directory entry lock, providing the first directory entry lock to a first caller of the first request, providing the second directory entry lock to a second caller of the second request, placing an entry corresponding to the first directory entry lock on a first dynamic lock list associated with a first directory, and placing an entry corresponding to the second directory entry lock on a first dynamic lock list associated with a first directory, processing, in parallel, the first request and the second request.

In general, in one aspect, the invention relates to a system, comprising a first directory associated with a file system, wherein the first directory is configured to store a first directory entry, a dynamic lock list associated with the first directory and configured to store a first entry corresponding to a first directory entry lock associated with the first directory entry, wherein the system is configured to receive a first request to modify the first directory entry, instantiate the first directory entry lock, provide the first directory entry lock to a first caller of the first request, place the first entry corresponding to the first directory entry lock on the first dynamic lock list.

Other aspects of the invention will be apparent from the following description and the appended claims.

### BRIEF DESCRIPTION OF DRAWINGS

FIG. 1 shows a file system in accordance with one embodiment of the invention.

FIG. 2 shows a flowchart in accordance with one embodiment of the invention.

FIGS. 3 and 4 show flow diagrams in accordance with one embodiment of the invention.

FIG. 5 shows a computer system in accordance with one embodiment of the invention.

### DESCRIPTION

Specific embodiments of the invention will now be described in detail with reference to the accompanying figures. Like elements in the various figures are denoted by like reference numerals for consistency.

In the following detailed description of one or more embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

In general, embodiments of the invention relate to a method and system for directory entry locking. More specifically, embodiments of the invention are directed to a mechanism for locking individual entries within a directory associated with a file system, where the directory entries correspond to file names in the directory.

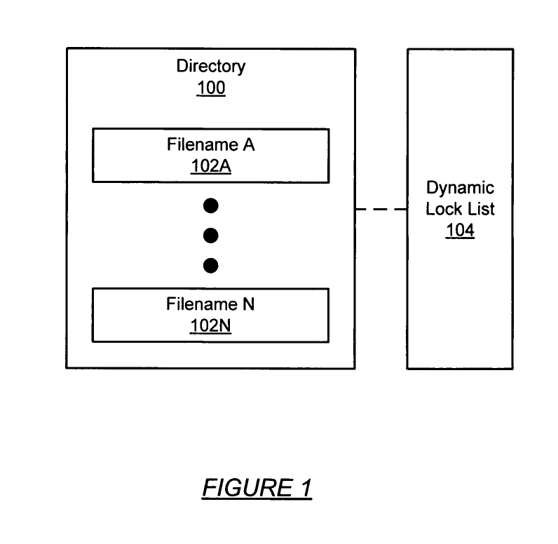

FIG. 1 shows a file system directory (100) in accordance with one embodiment of the invention. As shown in FIG. 1, the directory (100) is configured to store one or more directory entries (i.e., Filename A (102A), Filename N (102N)), where each directory entry corresponds to a filename of file used in the file system (not shown). Those skilled in the art will appreciate that any data structure may be used to implement the directory (100). Further, each of the directory entries (e.g., 102A, 102N) in the directory (100) may be individually locked. Said another way, the directory entries (102A, 102N) may be locked on a per-directory entry basis.

As shown in FIG. 1, the directory (100) is associated with a dynamic lock list (104). In one embodiment of the invention, the dynamic lock list (104) is configured to store a listing of directory entry locks currently being used to lock directory entries (102A, 102N) in (or associated with) the directory (100). In one embodiment of the invention, directory entry locks that are currently active in the directory (100) correspond to directory entry locks held by one or more processes, where each directory entry lock is associated with a particular directory entry (102A, 102N) in the directory (100). Those skilled in the art will appreciate that the dynamic lock list (104) may be located at any location in the system that is accessible to the processes using the directory (100). Further, the dynamic lock list (104) may be implemented using any data structure.

In one embodiment of the invention, no directory entry locks exist when the directory (100) is initially deployed. Rather, directory entry locks are only created as required (i.e., when a request to modify the content in the directory is received). Further, once the request has been processed, the directory entry lock may be maintained in the system or it may be removed from the system. In the cases where it is removed from the system, if the same directory entry lock is subsequently requested, then the lock must be re-instantiated.

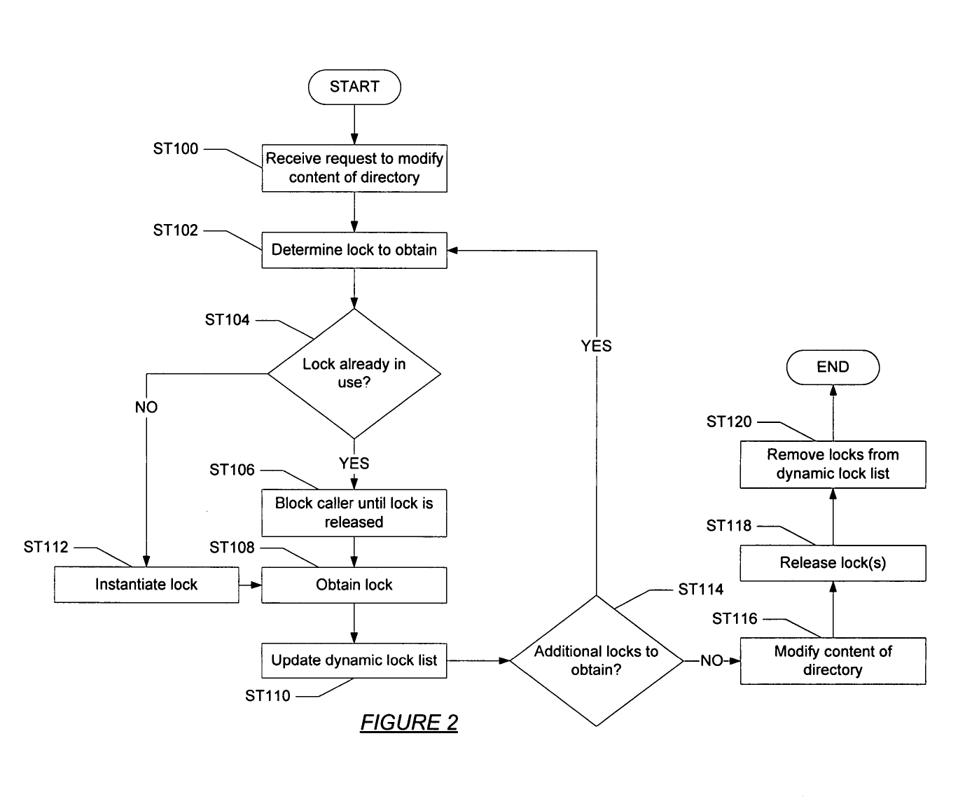

In one embodiment of the invention, a file system implementing the directory (100) and the dynamic lock list (104) shown in FIG. 1 includes the functionality to execute the method shown in FIG. 2.

FIG. 2 shows a flowchart in accordance with one embodiment of the invention. Initially, a request to modify the content of a directory entry is received by the directory (ST100). The request may correspond to, but is not limited to, creating a new entry, renaming an entry, and deleting an entry. Once the request is received, a determination is made about which directory entry lock(s) to obtain (i.e., determine a directory entry lock(s) required to perform the request) (ST102). A determination is then made about whether the directory entry lock is already in use (ST104). In one embodiment of the invention, determining whether the directory entry lock is already in use includes querying the dynamic lock list associated with the directory for the presence of the directory entry lock that the caller (i.e., the process that sent the request) is attempting to obtain.

If the directory entry lock is already in use, then the caller is blocked until the directory entry lock is released (ST106). Once the directory entry lock is released (i.e., when the process currently holding the directory entry lock has finished using the directory entry lock), the directory entry lock is obtained by the caller (ST108).

If the directory entry lock is not in use, then the directory entry lock is instantiated (ST112). In one embodiment of the invention, instantiating the lock includes instantiating a mutex associated with the directory entry that is to be locked in order to process the request. Once the directory entry lock has been instantiated, the directory entry lock is obtained by/given to the caller (ST108).

Once the directory entry lock has been given to the caller, the dynamic lock list is updated to reflect that the directory entry lock is not available to a subsequent caller (i.e., the directory entry is now locked) (ST110). In one embodiment of the invention, updating the dynamic lock list includes placing for example, the name of the directory entry lock on the dynamic lock list, where the name of the directory entry lock includes the directory entry name with which it is associated.

Once the dynamic lock list has been updated to reflect that the directory entry lock is now held by a caller, a determination is made about whether any additional directory entry locks are required by the caller for the caller to process the request (ST114). If additional directory entry locks are required, then the method proceeds to ST102.

Once all the directory entry locks are obtained, the caller then proceeds to modify the content of the directory in accordance with the request (ST116). After the content of the directory has been modified, the directory entry lock (or locks) is released by the caller (ST18). Once the directory entry lock(s) is released, the directory entry (or entries) corresponding to the directory entry lock (or locks) on the dynamic lock list is removed from the dynamic lock list (ST120).

Though not shown in FIG. 2, once the directory entry lock(s) has been released, the directory entry lock(s) may be removed from the system or it may be stored in the system until such time as the directory entry lock(s) is required. If the directory entry lock(s) is stored in the system, then prior to ST112, discussed above, the system may be queried to determine whether the directory entry lock(s) has been previously instantiated. If the directory entry lock(s) has already been instantiated, then the directory entry lock(s) are not instantiated; rather, the directory entry lock(s) are just obtained from their current location in the system.

In one or more embodiments of the invention, the system shown in FIG. 1 (using the method shown in FIG. 2) allows a directory to simultaneously process requests that are directed to separate entries in the directory.

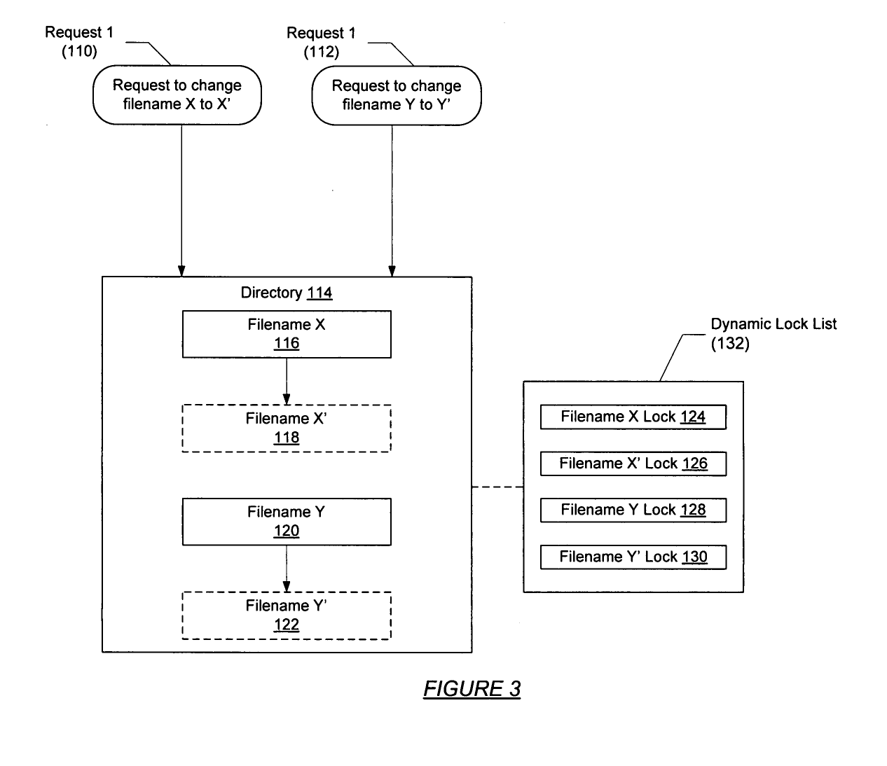

FIG. 3 shows a flow diagram in accordance with one embodiment of the invention. More specifically, FIG. 3 shows an example in which two requests (i.e., request 1 (110) and request 2 (112)) are simultaneously received by the directory (114). In this example, request 1 (110) is to change filename X (116) to X′ (118) and request 2 (112) is to change filename Y (120) to Y′ (122). In accordance with the method discussed in FIG. 2, in order for the request 1 (110) to be processed, two directory entry locks are required: one for the directory entry corresponding to filename X (116) (i.e., Filename X Lock (124)) and one for the directory entry corresponding to filename X′ (118) (i.e., Filename X′ Lock (126)). Further, in order for the request 2 (112) to be processed, two directory entry locks are required: one for the directory entry corresponding to filename Y (120) (i.e., Filename Y Lock (128)) and one for the directory entry corresponding to filename Y′ (122) (i.e., Filename Y′ Lock (130)).

In one embodiment of the invention, each of the aforementioned directory entry locks is obtained in lexicographic order (i.e., Filename X Lock (124), Filename X′ Lock (126), Filename Y Lock (128), Filename Y′ Lock (130)) to avoid dead locking due to inconsistent locking order. Those skilled in the art will appreciate that other ordering schemes of obtaining directory entry locks for simultaneously received requests may be used. Once Filename X Lock (124) and Filename X′ Lock (126) are obtained, request 1 may be processed. Similarly, once Filename Y Lock (128) and Filename Y′ Lock (130) are obtained, request 2 may be processed. In this example, once aforementioned the respective directory entry locks are received, the requests (i.e., requests 1 and 2) may proceed in parallel.

Once a given request is completed, the directory entry locks obtained to process the request are released and the dynamic lock list (132) is updated accordingly. For example, once request 2 is completed, Filename Y Lock (128) and Filename Y′ Lock (130) are released by the caller (i.e., the process that sent request 2) and entries corresponding directory entry locks Y and Y′ are removed from the dynamic lock list (132).

Those skilled in the art will appreciate that while the example shown in FIG. 3 is directed to a single directory receiving simultaneous requests, the invention may also be used to handle non-simultaneous requests that nonetheless may be processed in parallel.

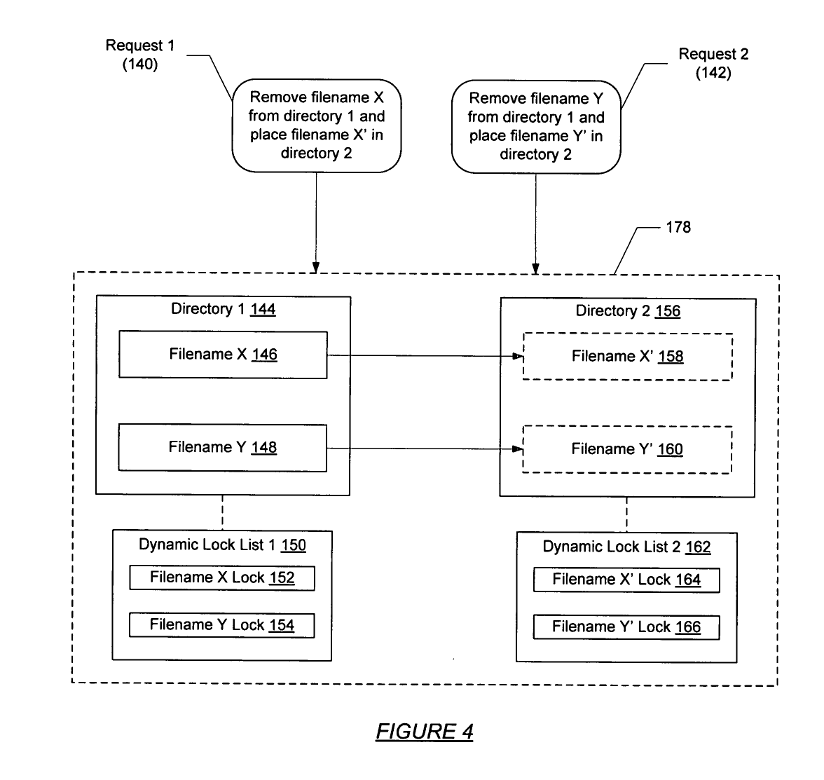

In one embodiment of the invention, a given system may include more than one directory. In such cases, each directory is associated with its own dynamic lock list. Further, a single request may require directory entry locks from two different directories. FIG. 4 shows a block diagram in accordance with one embodiment of the invention. More specifically, in the block diagram shows an example of two simultaneous requests received by a system (178) that includes two directories (144, 156).

As shown in FIG. 4, request 1 (140) is to remove filename X (146) from directory 1 (144) and add filename X′ (158) to directory 2 (156). Similarly, request 2 (142) is to remove filename Y (148) from directory 1 (144) and add filename Y′ (156) to directory 2 (160). The aforementioned requests may correspond to renaming files into a different directory.

In accordance with the method discussed in FIG. 2, in order for the request 1 (140) to be processed, two directory entry locks are required: one for the directory entry corresponding to filename X (146) from directory 1 (144) (i.e., Filename X Lock (152)) and one for the directory entry corresponding to filename X′ (158) from directory 2 (156) (i.e., Filename X′ Lock (164)). Further, in order for the request 2 (142) to be processed, two directory locks are required: one for the directory entry corresponding to filename Y (148) from directory 1 (144) (i.e., Filename Y Lock (154)) and one for the directory entry corresponding to filename Y′ (160) from directory 2 (156) (i.e., Filename Y′ Lock (166)).

In one embodiment of the invention, each of the aforementioned directory entry locks is obtained in lexicographic order (i.e., X, X′, Y, Y′). Those skilled in the art will appreciate that other ordering schemes of obtaining directory entry locks for simultaneously received requests may be used. Once Filename X Lock (152) and Filename X′ Lock (164) are obtained, request 1 (140) may be processed. Similarly, once Filename Y Lock (154) and Filename Y′ Lock (166) are obtained, request 2 (142) may be processed. In this example, once the respective directory entry locks are received, the requests (i.e., requests 1 (140) and 2 (142)) may proceed in parallel.

Once a given request is completed, the directory entry locks obtained to process the request are released and the corresponding dynamic lock lists (150, 162) are updated accordingly. For example, once request 2 is completed, Filename Y Lock (154) and Filename Y′ Lock (166) are released by the caller (i.e., the process that sent request 2) and entries corresponding Filename Y Lock (154) and Filename Y′ Lock (166) are removed from the appropriate dynamic lock lists (150, 162).

Those skilled in the art will appreciate that while the example shown in FIG. 4 is directed to multiple directories receiving simultaneous requests, the invention may also be used to handle non-simultaneous requests that nonetheless may be processed in parallel.

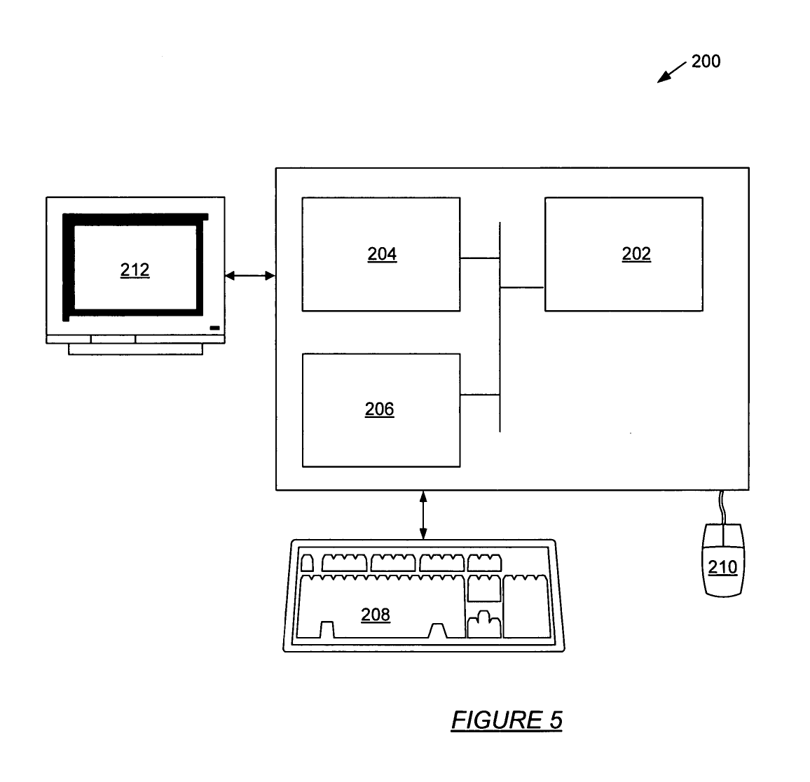

The invention may be implemented on virtually any type of computer regardless of the platform being used. For example, as shown in FIG. 5, a networked computer system (200) includes a processor (202), associated memory (204), a storage device (206), and numerous other elements and functionalities typical of today's computers (not shown). The networked computer (200) may also include input means, such as a keyboard (208) and a mouse (210), and output means, such as a monitor (212). The networked computer system (200) is connected to a local area network (LAN) or a wide area network (e.g., the Internet) (not shown) via a network interface connection (not shown). Those skilled in the art will appreciate that these input and output means may take other forms.

Further, those skilled in the art will appreciate that one or more elements of the aforementioned computer (200) may be located at a remote location and connected to the other elements over a network. Further, the invention may be implemented on a distributed system having a plurality of nodes, where each portion of the invention may be located on a different node within the distributed system. In one embodiment of the invention, the node corresponds to a computer system. Alternatively, the node may correspond to a processor with associated physical memory.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for modifying a directory entry comprising:
receiving a request to modify the directory entry;
determining whether a directory entry lock associated with the directory entry is present;
instantiating the directory entry lock, if the directory entry lock associated with the directory entry is not present;
waiting until the directory entry lock is released, if the directory entry lock is present;
providing the directory entry lock to a caller of the request;
placing an entry corresponding to the directory entry lock on a dynamic lock list associated with the directory;
processing the request by the caller;
releasing the directory entry lock once the request has been processed; and
removing the entry corresponding to the directory entry lock from the dynamic lock list.

2. The method of claim 1, wherein determining whether a directory entry lock associated with the specific directory entry is present comprises searching the dynamic lock list.

3. The method of claim 1, wherein the directory entry corresponds to a filename.

4. The method of claim 1, wherein the request to modify the entry comprises a request change a filename in the directory.

5. The method of claim 1, wherein the directory entry lock corresponds to a mutex.

6. A method for modifying a first directory entry and a second directory comprising:
receiving a first request to modify the first directory entry;
receiving a second request to modify the second directory entry;
instantiating a first directory entry lock and a second directory entry lock;
providing the first directory entry lock to a first caller of the first request;
providing the second directory entry lock to a second caller of the second request;
placing an entry corresponding to the first directory entry lock on a first dynamic lock list associated with a first directory; and
placing an entry corresponding to the second directory entry lock on a first dynamic lock list associated with a first directory;
processing, in parallel, the first request and the second request.

7. The method of claim 6, further comprising:
releasing the first directory entry lock once the first request has been processed;
releasing the second directory entry lock once the second request has been processed;
removing the entry corresponding to the first directory entry lock from the dynamic lock list; and
removing the entry corresponding to the second directory entry lock from the dynamic lock list.

8. The method of claim 6, further comprising:
receiving a third request to modify a third directory entry and a fourth directory entry;
instantiating a third directory entry lock;
instantiating a fourth directory entry lock;
providing the third directory entry lock and the fourth directory lock to a third caller of the third request;
placing an entry corresponding to the third directory entry lock on the first dynamic lock list associated with the first directory;
placing an entry corresponding to the fourth directory entry lock on a second dynamic lock list associated with a second directory; and
processing, in parallel, the first request and the third request.

9. The method of claim 6, wherein the first directory entry corresponds to a filename.

10. The method of claim 6, wherein the first request comprises a request change a filename in the first directory.

11. The method of claim 6, wherein the first directory entry lock corresponds to a mutex.

12. A system, comprising:
a first directory associated with a file system, wherein the first directory is configured to store a first directory entry;
a dynamic lock list associated with the first directory and configured to store a first entry corresponding to a first directory entry lock associated with the first directory entry,
wherein the system is configured to:
receive a first request to modify the first directory entry;
instantiate the first directory entry lock;
provide the first directory entry lock to a first caller of the first request;
place the first entry corresponding to the first directory entry lock on the first dynamic lock list.

13. The system of claim 12, wherein the system is further configured to:
receive a second request to modify a second directory entry;
instantiate a second directory entry lock;
providing the second directory entry lock to a first caller of the first request;
place a second entry corresponding to the second directory entry lock on the first dynamic lock list; and
processes, in parallel, the first request and the second request.

14. The system of claim 13, further comprising:
a second directory associated with the file system, wherein the second directory is configured to store a fourth directory entry;
a second dynamic lock list associated with the second directory and configured to store a fourth entry corresponding to a fourth directory entry lock associated with the fourth directory entry,
wherein the system is configured to:
receive a third request to modify the third directory entry and the fourth directory entry;
instantiate a third directory entry lock;
instantiate the fourth directory entry lock;
provide the third directory entry lock and the fourth directory lock to a third caller of the third request;
place a third entry corresponding to the third directory entry lock on the first dynamic lock list;
place the fourth entry corresponding to the fourth directory entry lock on the second dynamic lock list; and
process, in parallel, the first request and the third request.

15. The system of claim 12, wherein the first directory entry corresponds to a filename.

16. The system of claim 12, wherein the first request comprises a request change a filename in the first directory.

17. The system of claim 12, wherein the first directory entry lock corresponds to a mutex.
